(19) United States
(12) Patent Application Publication
(10) Pub. No.: US 2005/0181339 A1
(43) Pub. Date: Aug. 18, 2005

(54) Developing the twelve cognitive functions of individuals

(76) Inventor: Roger D. Hewson, Raymond, ME (US)

Correspondence Address: Roger D. Hewson, 22 Hewson Rd., P.O. Box 38, South Casco, ME, 04077, US

(21) Appl. No.: 10/780,831

(22) Filed: Feb. 18, 2004

(51) Int. Cl. G09B 19/00

(52) U.S. Cl. 434/236

(57) ABSTRACT

A system and method defining the twelve modular functions of cognition, and using this information to identify individual work style preferences and to facilitate individual and leadership competence development programs. The system and method associates sets of two related pairs of the cognitive functions with each of the three cognitive sectors of Reasoning logically, Relating to others, and taking Action. A preference survey instrument includes sets of any combination of statements, words, questions, or behaviors related to traits common to each of the functions, and defines a set of six preferred functions based on responses to each item in the instrument.

### CROSS-REFERENCE TO RELATED APPLICATIONS

Not applicable.

### FEDERALLY SPONSORED RESEARCH

Not applicable.

### SEQUENCE LISTING OR PROGRAM

Not applicable.

### BACKGROUND OF THE INVENTION

1. Field of the Invention

The present invention relates to a system and method defining the innate cognitive functions of all individuals and discovering the unique characteristics of each of these functions, and, more particularly, relates to systems and methods to use this new knowledge of innate cognitive functions as a development process to improve individual competencies and executive effectiveness.

2. Description of the Prior Art

The success of any individual, organization, or undertaking is dependent upon the abilities and interests of the individuals involved. Therefore, having an understanding of the innate cognitive functions of all individuals, and the necessity of using each of these functions competently for overall effective leadership, increases the likelihood of success of an individual, organization, or undertaking. Further, understanding an individual's level of preference for, and comfort using, each of the functions is an important component of success in relating to others and helps individuals choose positions that most closely match their interests, motivations and abilities. Unfortunately, current methods of identifying the innate cognitive functions of individuals are inadequate in defining the full spectrum of human thinking in both personal and business situations. Further, current methods of identifying, measuring, and developing the effective use of these innate functions relevant to leadership success in any undertaking are inadequate. Yet further, current methods for identifying weak or inappropriate use of each function of this invention and either strengthening those functions or accommodating them are more notably inadequate and incomplete.

Carl Jung in his book, Psychological Types, first published in English in 1922, defined the polar-opposites elements of introversion and extroversion as two ways of relating to the world. He also defined sensing and intuition as two ways to perceive, and thinking and feeling as two ways of judging. His research was based on psychiatric treatments of his individual medical patients, and was not related to activities and behaviors in normal life, in organizations, and in businesses. The psychology-based words and descriptions used in his book to identify and define each of these elements are now incomplete, inappropriate and inconsistent with normal and usual behaviors, actions, and word definitions in the 21st century.

Katherine Briggs and her daughter Isabel Briggs Myers further developed Jung's ideas and concepts by adding Jung's “perceiving” and “judging” as a fourth pair of elements, forming the Myers-Briggs Type Indicator® (known as the MBTI®). Their format of determining an individual's preferences for one element or the other in each of the four pairs is now well established. It is used to determine an individual's psychological “type” among the sixteen possible type combinations formed by an individual's preference for one or the other of each pair of the eight related elements. It inappropriately categorizes individuals as having only one distinctive “type” of behavior and thinking that will govern all their activities, which is decidedly not the case in the many varying situations individuals encounter in the course of normal and usual activities. It also inappropriately assumes that an individual with only a slight preference for one element in a pair will behave in the same way as an individual with a very strong preference for the same element in the pair. It should be noted that the original research behind the MBTI was mainly in personal and family settings, rather than in organizational and business settings. (Please note that cognitive and thinking components of prior art systems and methods are referred to as “elements” for clarity, as they are variously referred to as elements, attitudes, orientations, functions, or processes by others.)

The MBTI uses language and descriptions inconsistent with contemporary usage. Its definitions of the individual elements are currently confusing and ambiguous, and in conflict with dictionary descriptions of the words used to describe its eight elements. Further, the MBTI does not define the specific cognitive elements associated with reasoning logically, the specific elements associated with relating to others, and the specific elements associated with taking action to produce results.

The MBTI attributes some specific traits to the eight MBTI elements that are inconsistent and in conflict with the present understanding of cognition. Its eight elements do not cover the complete spectrum of cognition, and do not adequately cover the importance of competence in all of its elements to deal effectively with issues and activities that are normal and usual.

The following is an analysis of the eight elements of the MBTI in four related pairs as described in the MBTI Manual (1998), as published by the Consulting Psychologists Press, Inc., on page 6 and further defined on pages 24 to 27. The eight MBTI elements are aligned in an arbitrary choice of left and right columns, without identifying specific characteristics common to all of the elements in each of the left and right columns. The upper case code letters after the name of each element are their choice of a concise way of identifying their eight elements. (Note their unusual spelling of the word extraversion.)

| LEFT | RIGHT |
|---|---|
| Extraversion (E) | Introversion (I) |
| Sensing (S) | Intuition (N) |
| Thinking (T) | Feeling (F) |
| Judging (J) | Perceiving (P) |

The shortcomings, differences and incompleteness of each of the MBTI elements are detailed below. The quotations noted are from page 6 and from pages 24 through 27 of the MBTI Manual, Third Edition (1998). This manual, published by the Consulting Psychologists Press, Inc., was authored by Myers, McCaulay, Quenk, and Hammer. This manual, considered the ultimate authority for understanding the MBTI, is used as the basis for qualifying individuals to administer this program. A review of this manual further indicates the shortcomings and deficiencies of the MBTI concept in providing a complete system and method to assist individuals in developing their full cognitive abilities.

The MBTI “extraversion” element is defined as “Directing energy mainly toward the outer world of people and objects,” with “an awareness of and reliance on the environment for stimulation and guidance . . . an action oriented, sometimes impulsive way of meeting life . . . an openness to new experiences.” This MBTI element confusingly combines traits including communicating, cooperation, independence and courage that are more appropriately categorized in different cognitive elements.

The MBTI “introversion” element is defined as “Directing energy mainly toward the inner world of experiences and ideas.” It notes how “energy is drawn from the environment toward inner experience,” and how an individual “desires to stay focused on the internal subjective state, to affirm its value, and to maintain this focus as long as possible.” This MBTI element confusingly combines traits of contemplated detachment, reliance on enduring concepts and ideas, enjoyment of solitude and privacy that would be more appropriately categorized in the other cognitive elements.

The MBTI “sensing” element is referred to as “Focusing mainly on what can be perceived by the five senses.” It notes “acute powers of observation, . . . tending to enjoyment of the present moment . . . attuned to incoming information . . . intent on observing and experiencing . . . ”. This ambiguous and incomplete element does not take into account the need for a cognitive element clearly defining the present situation plus past experiences as a starting point of all cognition. It further does not anticipate the need for understanding this element as a left-brain style serial processing activity divergently considering the many independent components of a situation.

The MBTI “intuition” element ambiguously and incompletely refers to “perception of possibilities, meanings and relationships by way of insight,” and further refers to “hunches, and sudden discovery of patterns in unrelated events.” Note that the inappropriate use of the word intuition to define this element is inconsistent with current dictionary definitions of the word. This intuition element does not take into account the need for an element clearly defining the imagination of future situations and possibilities. It further does not anticipate the need for understanding this element as a right-brain style parallel processing activity composed of considering the overall convergent nature of all facets of the situation. Various traits attributed to this MBTI element are in direct conflict with the conventional understanding of intuition, causing great difficulty in applying this MBTI concept in real life situations.

The MBTI “thinking” element refers to “Basing conclusions on logical analysis with a focus on objectivity and detachment,” and “comes to a decision by linking ideas together by logical connections. Thinking relies on principles of cause and effect.” This ambiguous and incomplete element not take into account the need for understanding the function as a left-brain style serial processing activity divergently considering the many independent components of a situation. The definition of this element is in direct conflict with the conventional understanding of thinking, causing great difficulty in applying this MBTI concept in real life situations.

The MBTI “feeling” element refers to “Basing conclusions on personal values with a focus on understanding and harmony,” and “by which one comes to decisions by weighing relative values and merits of the issue” . . . , with “an understanding of personal values and group values . . . ,” and a “concern with the human as opposed to technical aspects of problems, a desire for affiliation, warmth, and harmony and a time orientation that includes preservation of enduring values.” This ambiguous and incomplete MBTI feeling element does not anticipate the need for understanding this element as an intuitive right-brain style parallel processing activity. It inappropriately combines many traits more appropriately associated with very different cognitive elements. The definition of this element is in direct conflict with the conventional understanding of feeling, causing great difficulty in applying this MBTI concept in real life situations.

The MBTI “judging” element refers to “closure that results with dealing with the outer world using one of the judging processess [of thinking and feeling].” It is further referred to as “planning operations, or organizing activities.” This ambiguous and incomplete element does not anticipate the need for understanding this element as a right-brain style parallel processing activity composed of considering the overall convergent nature of all facets of the situation. The definition of this element is very different than the conventional understanding of judging, causing great difficulty in applying this MBTI concept in real life situations.

The MBTI “perceiving” element refers to “the flexibility and spontaneity that results from dealing with the outer world using one of the perceiving processes [of sensing and intuition].” It further refers to being “attuned to incoming information . . . the immediate realities in the environment.” This ambiguous and incomplete element does not take into account the need for understanding the function as a left-brain style serial processing activity divergently considering the many independent components of a situation. The definition of this element is very different than the conventional understanding of perceiving, causing great difficulty in applying this MBTI concept in real life situations.

The MBTI does not anticipate the need for further elements provide a comprehensive system and method covering the full spectrum of cognition. It further does not anticipate the need for elements covering such important and normal cognitive actions and behaviors such as cooperation, independence, caution, and courage. Further, it ambiguously includes traits in its eight elements that are more appropriately part of other cognitive elements.

MBTI has the “requirement to sort individuals into opposite categories rather than to measure an amount or degree” of a preference (page 5 of the manual). This does not anticipate the need to recognize that a very strong preference for any cognitive element will result in very different style of behavior than only a slight preference for the same element. Further, the MBTI does not consider the importance of developing competence in each of its elements, which is very important in relating to a group of individuals in leadership activities.

The differences between the Myers-Briggs Type Indicator and the present invention are substantial, distinct and material, particularly related to the nature and details of their limited and incomplete number of cognitive elements, the inappropriate categorization of many traits to specific elements, and the difficulty of using the systems and methods of this indicator in usual and normal daily situations.

In addition to the MBTI, there are a large number of other programs, or “tests,” to assess and measure psychological traits, elements, and functions. Most are proprietary in nature. More than eighty are noted in Edward Hoffman's book, Psychological Testing at Work (2002). Each test provides an incremental way of understanding people, and each has been designed for a specific purpose, but none have the comprehensive nature of the present invention. None anticipate the present invention and possess the unique and novel characteristics of the present invention.

An example of a typical program is the proprietary Predictive Index program by Praendex Incorporated, 40 Washington St, Wellesley Hills, Mass. 02181 (www.praendex.com). It surveys the extent of preference of an individual on four element scales defined as A, B, C, and D, which can be interpreted approximately as assertiveness, sociability, pace, and conformity. From this survey, it types individuals into one of about fifteen types such as Production Technician, Scientific Professional, and Creative Analytical. This program, like the others in this prior art search, does not relate elements to a comprehensive cognitive element concept, does not consider left and right brain style attributes to the elements and does not consider the importance of developing individual capabilities in each of the elements. The differences between this concept and the invention presently claimed are substantial, distinct, and material.

Further, none of these tests anticipate the need for a specific definition of the left-brain and right-brain style characteristics of cognition. None anticipate the need of defining their elements in the three distinct cognitive sectors of reasoning to personally evaluate a situation, relating to act in harmony with others, and action to achieve results effectively.

It is typical of present psychological tests, aptitude surveys, and preference assessments to be focused on measuring the interests, abilities, and preferences of an individual in a proprietary way that gives those giving the test insight into the personality of the individual. This can be valuable in choosing an individual for a specific role in business, and can help individuals find work most suited to their unique abilities. However, none provide this information in a way that facilitates identifying and developing competencies in each of the twelve necessary cognitive functions of effective leadership provided by the present invention. Also, most, if not all, of these programs focus solely on building on the strengths identified by surveys or assessments, and fail to consider the importance of understanding and improving the capabilities of less preferred or weak elements of cognition to avoid having them become limitations to success.

A thorough search of prior art, and in particular any patents or patent applications listed with the patent office, has failed to identify any prior art that anticipates the concept of the present invention. They all seem to fail to provide a more complete evaluation method and application of this information as a personal development and executive development tool. The search was performed electronically using the publicly-available United States Patent and Trademark database of issued patents and published patent applications. Searches were generally performed by keyword using such words and phrases as: “Method and Business”; “Cognitive or Intelligence or Thinking”; and “leader$” (where . . . $ implies any ending to the word leader). Class searches of pertinent Patent Office Classes were also carried out after appropriate classifications were identified. None of the following patents, individually or relatedly coupled, contemplate the concept of this invention. The results of these searches are summarized below.

U.S. Patent Application No. 20020045154. Wood, Mark, and Milner. Apr. 18, 2002. Method and system for determining personal characteristics of an individual or group and using same to provide personalized advice and services. This patent addresses a method that incorporates assessments of several personality dimensions, life style, quality of life, cultural context, and psychographics, saves this information in a computer database, and uses this information to provide advice and services to individuals. This patent application describes the prior art of the Myers-Briggs Type Indicator and other personality evaluation concepts in great detail. This patent outlines the quadrant concept of “four quadrants of thinking styles” of a number of prior art concepts, often referred to as “temperaments.” However, this patent application, and the prior art cited, do not anticipate the unique and novel features of the present invention. The differences between this patent application and the invention presently claimed are substantial, distinct, and material.

U.S. Pat. No. 5,551,880. Bonnstetter and Hall. Sep. 3, 1996. Employee success prediction system. This patent addresses a method to evaluate the potential of an individual for a specific job by measuring, through a question and answer process, behavioral and value characteristics of the individual and relating them to predetermined values believed to be important for success in a specific job. Each specific job function apparently has a different set of desired characteristics. For a management job, twelve specific behavior categories are listed. These, however, are different from this invention since they do not seem to be grouped into opposing sets of two as they are in this concept. The differences between this invention and the one presently claimed are substantial, distinct, and material.

U.S. Pat. No. 5,795,155. Palmer Morrel-Samuels. Aug. 18, 1998. Leadership assessment tool and method. This patent is directed more toward an assessment of performance rather than as a predictor of potential performance. A number of “behavioral domains” are listed which reflect on the desired performance of a manager. The number of behavioral domains is flexible according to the statement, “ . . . the assessment tool may include all or only some of the above listed behavioral domains, as well as other behavioral domains.” The differences between this invention and the one presently claimed are substantial, distinct, and material.

U.S. Pat. No. 5,743,742. Palmer Morrel-Samuels. Apr. 28, 1998. System for measuring leadership effectiveness. This is another assessment tool (as the '155 patent, above) created by the same inventor and assigned to the same assignee as the '155 patent. Numerous “behavioral domains” are listed which are thought to describe an effective leader. As above in the '155 patent, all or only some of the behavioral domains listed may be employed. Others may also be added. Attempts are made to provide an assessment that is not prejudiced by the method of assessment and recording of the assessment. The differences between this invention and the one presently claimed are substantial, distinct, and material.

U.S. Pat. No. 6,007,340. Palmer Morrel-Samuels. Dec. 28, 1999. Method and system for measuring leadership effectiveness. This patent has the same inventor and assignee as the immediately preceding two patents. The claims of this patent indicate using at least one of the behavioral domains as described in the earlier patents. Non-standard behavioral domains and characteristics may be evaluated. The differences between this invention and the one presently claimed are substantial, distinct, and material.

U.S. Pat. No. 5,871,211. Michael C. Was. Feb. 16, 1999. Method and device for typing thinking styles. This patent involves a board game designed to be played simultaneously by a plurality of players. The object of the game is to identify the different thinking styles of the various players and to categorize them into preconceived distinct classes. The differences between this invention and the one presently claimed are substantial, distinct, and material.

U.S. Pat. No. 6,159,015. Buffington, Morgan, and Reisner. Dec. 12, 2000. Multi-dimensional awareness profiling method. The basis of this patent is determining the temperament type of an individual; determining preferences of the individual; correlating the above found results; and analyzing the correlation for insight into modification of behaviors. Opposed pairing of sensation and intuition and of thinking and feeling are invoked in one aspect of this invention, as defined in MBTI. The differences between this invention and the one presently claimed are substantial, distinct, and material.

A search of the internet has also failed to identify any item troublesome in the pursuit of this patent. The results of these searches are summarized below. None of the following references, individually or relatedly coupled, contemplate this concept in its entirety. All seem to fail to provide for a more complete evaluation method and application of this information as a management development tool similar to this invention.

www.badenemp.com At this site, Baden Employee Selection and Development Services outlines an assessment program for supervisors, managers and professionals. Their evaluation scheme contains some terms related to this invention.

www.hayresourcesdirect.haygroup.com The Hay group has developed a “Manager Competency Model” which includes 11 competencies organized into 4 clusters, namely, managing yourself, managing your team, managing work, and managing collaboratively.

www.renaissancelawyer.com/emotional_intelligence.htm This is a website discussing emotional assessment tools. In reference to a tool developed by Boyatzis and Goleman, a statement is made that a listing of 25 competencies was reduced to 20 in four quadrants.

www.selftrain.com/nc/megalearn.html This website appears to highlight a concept called “Mega Learning” which seems to be based on 12 different “intelligences” possessed by all individuals that assist in their capacity for learning. This appears to be a learning aid, and unrelated to the concept of cognitive elements.

None of the above concepts, inventions, and patents, taken singularly or in combination, is seen to anticipate or describe the present invention as claimed. The differences between each one of them and the one presently claimed are substantial and distinct.

What is needed is a system and method defining the innate cognitive functions of individuals, and a system and related method to acquire comprehensive information related to these innate cognitive functions of individuals. Further, what is needed is a system and related method to analyze the comprehensive cognitive function information acquired to establish an understanding of the cognitive functions of individuals as related to personal development and leadership capabilities. Yet further, what is needed is a system and related method to apply the analyzed cognitive function information to leadership development activities. In particular, such applications should include, but are not limited to: assessing the cognitive function preferences of individuals, groups, organizations, and geographic regions. Further, such applications should include, but are not limited to: assisting individuals in matching their cognitive function preferences with activities best using these preferences, developing team management abilities; developing leadership capabilities of individuals; and understanding the cultural differences between geographic regions and countries throughout the world.

### SUMMARY OF THE INVENTION

The disclosures of this patent document contain material that is subject to copyright protection. The copyright owner of this patent application, Roger Hewson, has no objection to the facsimile reproduction by anyone of a copy of this patent disclosure, as it appears in the Patent and Trademark Office patent files or records, but otherwise reserves all copyright rights whatsoever. (© 2004 Roger Hewson).

After 25 years of experience with direct and total authority over more than 100 employees each year, the inventor of this invention arrived at the conclusion that no program or method exists that adequately provides the needs being met by this invention. This experience included being a qualified administrator of both of the above noted Myers-Briggs Type Indicator and Praendex's Predictive Index programs, and using both extensively to develop management capabilities in business settings.

It is an object of the present invention to develop a system and method to define the fundamental cognitive function elements of human thinking, and to provide a system and method to acquire information related to the cognitive functions of individuals, groups, organizations, and geographic regions. Further, it is an object of the present invention to provide a system and method to apply this cognitive function information to better understand the preferred mode of thinking and cultural influences of individuals, groups, organizations, and geographic regions. Yet further, it is an object of the present invention to provide a system and method to analyze this information to establish an understanding of the cognitive function preferences of individuals relative to their work style preferences and leadership development needs, and to assist in developing improved leadership capabilities.

These and other objects are achieved in the present invention. The invention is a comprehensive system and method involving the use of individual cognitive information to develop the cognitive abilities and leadership capabilities of individuals. It is also a system and method that enables the use of a development program based on cognitive functions in practice as a way to increase the likelihood of success of an individual, project, team, or organization in achieving established goals. Further, it is a system and method that enables use of this cognitive preference information to assist individuals in finding roles appropriate to their cognitive preferences in an organization or project. Yet further, it is a system and method that enables individuals to target for improvement any weak functions of leadership importance so each function may be developed and used in the optimum way for its appropriate purpose and at the appropriate time. This system and method is configured to utilize an array of individual function preference evaluation information. However, it preferably employs the comprehensive evaluation methodology developed and described herein.

The concept of this invention is based on (a) segmenting the cognitive architecture of our innate thinking process into its unique modular components, called functions in this invention; (b) identifying the exact cognitive traits common to each cognitive function as readily observable and distinct elements of all behaviors and actions of individuals; (c) naming and describing each cognitive function in conventional language for ease of use and comprehension; (d) determining that individuals perform best and most comfortably when utilizing their preferred cognitive functions; (e) establishing that each of the cognitive functions is a necessary component of truly effective leadership; and (f) creating an individual and leadership development program based on improving competencies in each of these functions.

The twelve cognitive functions discovered in this invention are segmented into three cognitive sectors with similar and related cognitive purposes. These three sectors are defined as the Reasoning, Relating, and Action sectors, with four cognitive functions in each sector. First, the Reasoning sector uses Realism (cognitive function “A”) to size up a the present situation today, Imagination (B) to think of future possibilities, Analysis (C) to sort and evaluate the situation objectively, and Intuition (D) as a gut feeling or sixth sense to come to closure when details are missing. Secondly, the Relating sector uses Listening (E) to learn from and respect the thoughts of others, Expressing (F) to openly convey our thoughts to others, Cooperation (G) to develop rapport and teamwork with those around us, and Independence (H) to be able to act alone when appropriate. Thirdly, the Action sector uses Caution (I) to assess risks, Courage (J) to proceed in spite of the inevitable uncertainties and ambiguities of the situation, Adaptability (K) to stay open and flexible to new developments and opportunities, and Decisiveness (L) for closure in spite of the unpredictable aspects of doing anything new. (Note that the names of the three cognitive sectors and each of the twelve cognitive functions are capitalized for clarity, and that each cognitive function is usually identified with an upper case letter of the alphabet for further clarity and easy reference.)

The name of each cognitive function has been chosen as the dictionary word (or derivative words) most closely defining the usual and normal individual behaviors and cognitive traits associated with that function. Thus, the use of the Reality function may be referred to as Realism, Realistic, Realist, and other equivalent form to match the way words are used in everyday life. Any inconsistencies between the choice of verbs, nouns, and adjectives in describing the functions have been done to make their description more in line with the way language is commonly used.

This invention includes a code of conditions and rules that governs the use of the twelve cognitive functions, and the interaction of the functions with each other: (a) the functions are matched in pairs with complementary but polar-opposite attributes; (b) we all have a natural preference for one or the other cognitive function in each pair; (c) we are able to use only one function in a pair at a time; (d) our profile of preferred functions is a filter that forms a bias that affects all our thoughts and actions; (e) a person will often use a function opposite to the one they naturally prefer in situations of a different or unusual nature; (f) memories of all experiences are stored with both facts and feelings about the situation; (g) we all have strengths, non-strengths and weaknesses among the twelve functions, with different levels of competency in each of the functions; and (h) the extreme use of any of the functions can lead to it taking on negative characteristics by becoming overly dominant in the pair and causing the opposite partner in the pair to become ineffective.

The roles of specialists, managers, and leaders require different levels of competence in the full spectrum of twelve cognitive functions to correspond with the different levels of responsibility in specific positions. Specialists can often excel in their unique area of expertise relying on their preferred set of six functions without needing competence in all of the functions. Managers who administer the successful outcomes of established initiatives must be fully aware of the virtues of each of the functions and the appropriate use of individual functions by others. Leaders, to be truly effective, require an adequate level of competence in all of the twelve functions, in addition to exceptional talents in their own preferred set of six functions.

These and other advantages of the method and system of the present invention will be further apparent upon review of the following detailed description, consideration of the accompanying drawings, and reading of the appended claims.

### BRIEF DESCRIPTION OF THE DRAWINGS

FIG. 1 is a simplified block representation of the concept of the architecture of cognition as the sum of twelve cognitive functions, arranged in the three cognitive sectors of Reasoning, Relating and Action, and with the twelve cognitive functions arranged in complementary and polar opposite pairs of functions.

FIG. 2 is a simplified flowchart representing the arrangement of the twelve cognitive functions in columns of six left-brain style functions and six right-brain style functions.

FIG. 3 is a simplified block presentation of typical preference survey instrument instructions to aid an individual in completing a cognitive function preference survey instrument form.

FIG. 4 is a simplified block presentation of a typical preference survey instrument.

FIG. 5 is a simplified block diagram of a typical preference survey report form.

FIG. 6 is a simplified flow chart illustrating the use of a preference survey instrument as a means to inform an individual of his or her innate cognitive preferences, and to use this information in a personal development system.

FIG. 7 is a simplified flow diagram illustrating the use of a preference survey instrument as a means to inform individuals in a group of their innate cognitive preferences, and to use this information in a personal and group development system.

FIG. 8 is a simplified flow diagram illustrating the use of preference survey instrument(s) as a means for individual(s) to establish the cognitive function preferences of other entities, and to use this information to help individual(s) as a personal and group development system.

FIG. 9 is a simplified flow diagram illustrating the use of two pairs of functions of this invention, Cooperation plus Independence and Caution plus Courage, as a separate system and method to enhance the effectiveness and practical use of other unrelated cognitive element assessment methods.

FIG. 10 is a simplified flow diagram illustrating the use of the four Reasoning functions of this invention, Reality plus Imagination and Analysis plus Intution, as a separate system and method as a means to classify all Reasoning cognition into four cognitive quadrants.

### DETAILED DESCRIPTION OF PREFERRED EMBODIMENTS OF THE INVENTION

The objects and advantages of the present invention are:

(a) Segmenting the cognitive architecture of an individual's innate thinking process into a unique system of cognitive functions so each function can be clearly and explicitly defined and the character and attributes of each function clearly identified.

(b) Establishing that the twelve cognitive functions defined in this invention form the architecture of cognition and cover the full spectrum of innate cognitive processing.

(c) Naming and describing each cognitive function in conventional language for ease of use and comprehension in the dialog of day-to-day activities;

(d) Identifying that the readily observable and distinct cognitive traits of all behaviors and actions of individuals can be attributed to one of the twelve cognitive functions, can be a subset of a specific function, or can be attributed to a combination of functions;

(e) Determining that individuals perform best and are most motivated when utilizing their preferred cognitive functions;

(f) Establishing that each of the cognitive functions is a necessary component of truly effective leadership, acknowledging that those in specialist activities can be very effective by excelling in only a few of the twelve cognitive functions discovered in this invention; and

(g) Developing a leadership development program based on improving competencies in each of the twelve cognitive functions to assist individuals at all levels in becoming more effective in their personal and occupational lives.

The present invention describing the twelve functions covering the full spectrum of cognitive thinking is unique and novel compared to the MBTI, and is much more thorough and practical as an individual development and executive development system and method. More specifically, the exact and complete nature of each of the twelve cognitive functions described in the present invention is novel, unobvious, unanticipated, and substantially different from the elements of other prior art systems and methods.

Defining the Twelve Cognitive Functions

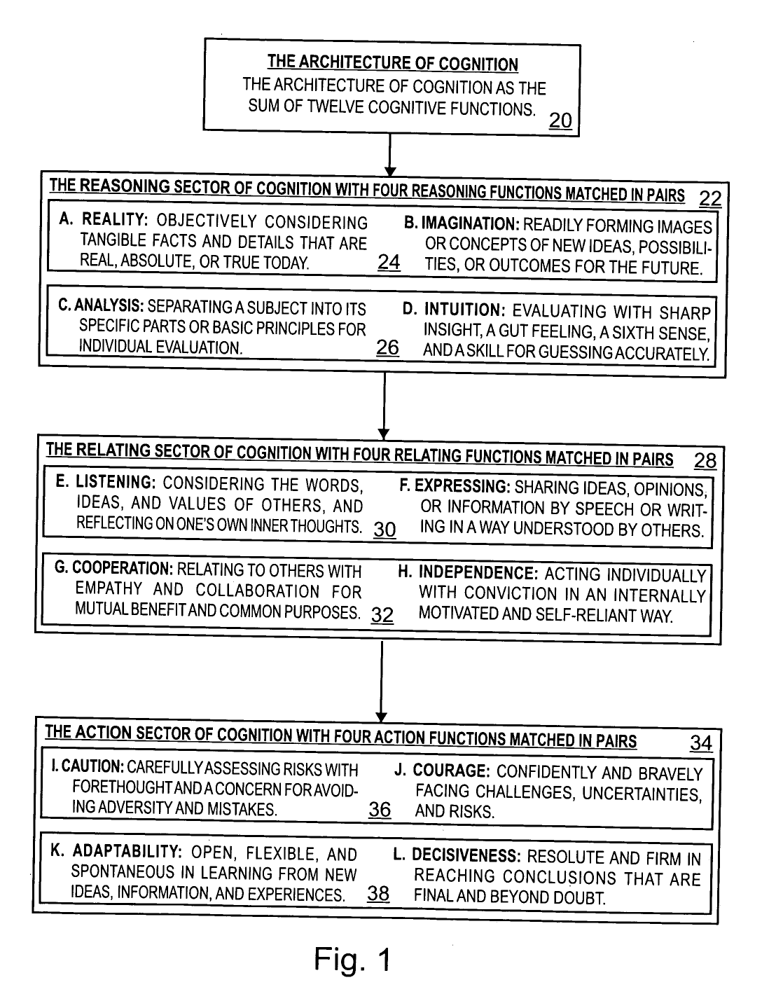

A definition of the twelve cognitive functions of this invention is referred to now in FIG. 1 of the drawings, presenting a diagram illustrating the architecture of cognition as the sum of twelve cognitive functions in block 20. Blocks 22, 28, and 34 represent the three distinct sectors of Reasoning, Relating, and Action, with four cognitive functions in each sector. The four functions represented in block 22 provide the cognitive ability to Reason effectively as an individual and logical thought process. The four functions represented in block 28 provide the cognitive ability to Relate to others effectively in team and group settings. The four functions represented in block 34 provide the cognitive ability to take Action effectively to produce results. The details of FIG. 1 are further illustrated and described as follows:

(a) The Reasoning sector represented in block 22, is an individual and logical thought process, and uses Realism (cognitive function A) to size up a situation, Imagination (B) to think of future possibilities, Analysis (C) to sort things objectively, and Intuition (D) as a gut feeling or sixth sense to come to closure when details are missing. Block 24 represents Reality and Imagination as the first Reasoning pair of complementary and polar-opposite functions, and block 26 represents Analysis and Intuition as a second Reasoning pair.

(b) The Relating sector, represented in block 28, provides the ability to work with others, using Listening (E) to learn from and respect the thoughts of others, Expressing (F) to convey thoughts to others, Cooperation (G) to develop rapport and teamwork with others, and Independence (H) to be able to act alone when appropriate. Block 30 represents Listening and Expressing as the first Relating pair of complementary and polar-opposite functions, and block 32 represents Cooperation and Independence as a second Relating pair.

(c) The Action sector, represented in block 34, provides the ability to achieve all meaningful results, using Caution (I) to assess risks, Courage (J) to proceed in spite of the inevitable uncertainties and ambiguities of the situation, Adaptability (K) to stay open and flexible to new developments and opportunities, and Decisiveness (L) to proceed in spite of the unpredictable aspects of doing anything new. Block 36 represents Caution and Courage as the first Action pair of complementary and polar-opposite functions, and block 38 represents Adaptability and Decisiveness as a second Action pair.

The Twelve Functions are Matched in Pairs

The twelve functions are matched in six pairs, as represented in blocks 24, 26, 30, 32, 36, and 38. Each function in a pair has complementary but polar-opposite attributes similar to east and west on the compass. The effectiveness of each function in a pair is increased by the way the two functions in a pair work together in a complementary and polar-opposite way, such as one hand to hold a piece of paper and the other to write a name, or first stepping on one foot and then the other to walk. The pairs are matched as follows:
Reasoning Sector: Reality (A) is paired with Imagination (B) in block 24, and Analysis (C) is paired with Intuition (D) in block 26.
Relating Sector: Listening (E) is paired with Expressing (F) in block 30, and Cooperation (G) is paired with Independence (H) in block 32.
Action Sector: Caution (I) is paired with Courage (J) in block 36, and Adaptability (K) is paired with Decisiveness (L) in block 38.

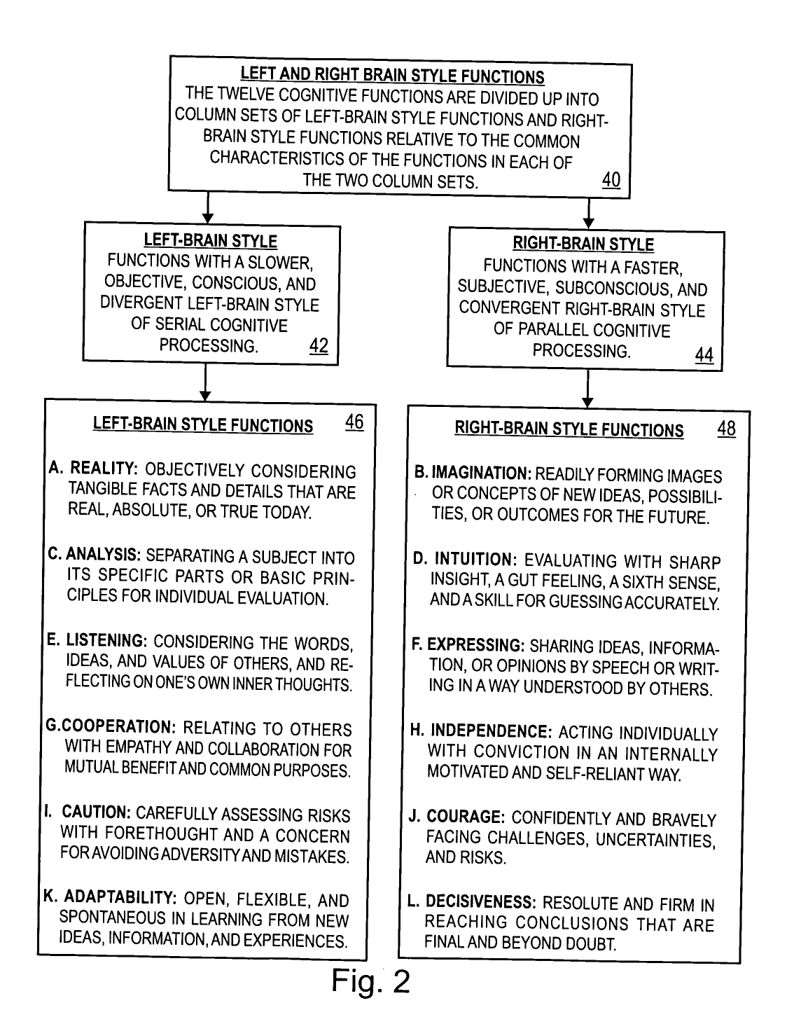

The first function in each pair has left-brain style serial processing attributes and the second function in each pair has right-brain style parallel processing attributes, as further detailed in FIG. 2.

The Four Reasoning Sector Functions

The four Reasoning sector functions (functions A through D), represented in block 22 of FIG. 1, define the components we use in methodically and logically thinking through the situation. Each is detailed as follows:

The Reality (A) function of Reasoning is objectively considering tangible facts and details that are real, absolute, or true today. A preference for this function, represented in block 24, is indicated by noted or observed preferences for: realistic, practical, and factual details; a focus on today's activities and challenges; a conventional and predictable approach; consistent and traditional ways of working; being conservative and down-to-earth; valuing known experiences and traditions; and other equivalents in single words, statements, and questions.

The Imagination (B) function of Reasoning is readily forming images or concepts of new ideas, possibilities, or outcomes for the future. A preference for this function, indicated in block 24, is indicated by noted or observed preferences for: innovative and original ideas; thinking of future possibilities and opportunities; being imaginative and unconventional; enjoying constantly changing situations; having an inquisitive and theoretical approach; favoring creative and experimental types of work; and other equivalents in the form of single words, statements, and questions.

The Analysis (C) function of Reasoning is separating a subject into its specific parts or basic principles for individual evaluation. A preference for this function, represented in block 26, is indicated by noted or observed preferences for: analytical and systematic reasoning; being rational and fair-minded in dealing with issues; segmenting issues into component parts; being objective and impersonal in solving problems; structuring activities into separate categories; making decisions in a methodical way; and other equivalents in the form of single words, statements, and questions.

The Intuition (D) function of Reasoning is evaluating with sharp insight, a gut feeling, a sixth sense, and a skill for guessing accurately. A preference for this function, represented in block 26, is indicated by noted or observed preferences for: an intuitive and personal way of reasoning; using a gut feeling to evaluate good and bad, and right and wrong; ranking issues in a subjective and qualitative way; taking into account relationships and social values; being thoughtful and understanding with people; deciding on the overall picture of what “feels” right; and other equivalents in the form of single words, statements, and questions.

The Four Relating Sector Functions

The four Relating functions (functions E through H), represented in block 28 of FIG. 1, define the four functions of the social context of leadership. They allow us to deal with the divergent interests, perspectives, and preferences of others when working in partner, team, and group activities. Each is detailed as follows:

The Listening (E) function of Relating is considering the words, ideas, and values of others, and reflecting on one's own inner thoughts. A preference for this function, represented in block 30, is indicated by noted or observed preferences for: a reflective, reserved style of working; quietly thinking things through; being calm and self-reliant in a humble way; being a listener in group settings; studying specific issues in depth; favoring working in a quiet setting; and other equivalents in the form of single words, statements, and questions.

The Expressing (F) function of Relating is sharing ideas, opinions, or information by speech or writing in a way understood by others. A preference for this function, represented in block 30, is indicated by noted or observed preferences for: having an outgoing and expressive way with people; a talk-it-out style of working with others; being influential and persuasive; valuing eloquence in relations with others; focusing on the broad dimensions of situations; enjoying working in a busy environment; and other equivalents in the form of single words, statements, and questions.

The Cooperation (G) function of Relating is showing empathy and collaboration with others for mutual benefit and common purposes. A preference for this function, represented in block 32, is indicated by noted or observed preferences for: being cooperative and agreeable; being diplomatic and understanding of others; being respectful and considerate; being accommodating and tolerant in group situations; collaborating with others on team efforts; being trusting and supportive of authority; and other equivalents in the form of single words, statements, and questions.

The Independence (H) function of Relating is acting individually with conviction in an internally motivated and self-reliant way. A preference for this function, represented in block 32, is indicated by noted or observed preferences for: being confident and in control; being independent and individualistic; being determined and competitive; being assertive in expressing viewpoints; being a self-starter in taking the initiative; being the person in charge of a situation; and other equivalents in the form of single words, statements, and questions.

The four Action Sector Functions

The four Action sector functions (functions I through L), represented in block 34 of FIG. 1, define the components of turning our Reasoning and Relating activities into meaningful results. They are described in detail as follows:

The Caution (I) function of Action is carefully assessing risks with forethought and a concern for avoiding adversity and mistakes. A preference for this function, represented in block 36, is indicated by noted or observed preferences for: a cautious and predictable way of life; avoiding risks and uncertainties; clearly understanding goals and procedures; accurately carrying out assignments; working in a persistent and disciplined style; having things orderly and consistent; and other equivalents in the form of single words, statements, and questions.

The Courage (J) function of Action is confidently and bravely facing challenges, uncertainties, and risks. A preference for this function, represented in block 36, is indicated by noted or observed preferences for: a courageous and adventurous way of life; being brave in dealing with situations; the challenge of implementing new strategies; the thrill of taking reasonable risks; accepting the uncertainties of new projects; being a venturesome pioneer; and other equivalents in the form of single words, statements, and questions.

The Adaptability (K) function of Action is being open, flexible, and spontaneous in learning from new ideas, information, and experiences. A preference for this function, represented in block 38, is indicated by noted or observed preferences for: being spontaneous and adaptable; keeping things open for the unexpected; waiting until the last minute in meeting deadlines; being happy when things are flexible and unplanned; searching for more information before deciding; a casual and easy going work environment; and other equivalents in the form of single words, statements, and questions.

The Decisiveness (L) function of Action is being resolute and firm in reaching conclusions that are final and beyond doubt. A preference for this function, represented in block 38, is indicated by noted or observed preferences for: coming to closure quickly on a situation; having things planned and scheduled; being punctual and orderly in meeting deadlines; having things settled well in advance; a decisive, urgent style of response; being definitive and precise; and other equivalents in the form of single words, statements, and questions.

The Left-Brain and Right-Brain Functions

The left-brain and right-brain style functions are referred to now in FIG. 2 of the drawings, illustrating a flow chart of the concept of left-brain and right-brain styles of cognitive functioning as represented in block 40. They are detailed as follows:

(a) The left-brain style, as represented in block 42, indicates a slower, objective, conscious, and divergent style of serial cognitive processing with ability to think separately about the individual parts that make up a whole. Block 46 lists the left-brain style functions of Reality, Analysis, Listening, Cooperation, Caution, and Adaptability.

(b) The right-brain style, as represented in block 44, indicates a faster, subjective, subconscious, and convergent style of parallel cognitive processing with the ability to see the big picture formed by combining a number of parts. Block 48 lists the right-brain style functions of Imagination, Intuition, Expressing, Independence, Courage, and Decisiveness.

The Preference Survey Instrument Instructions

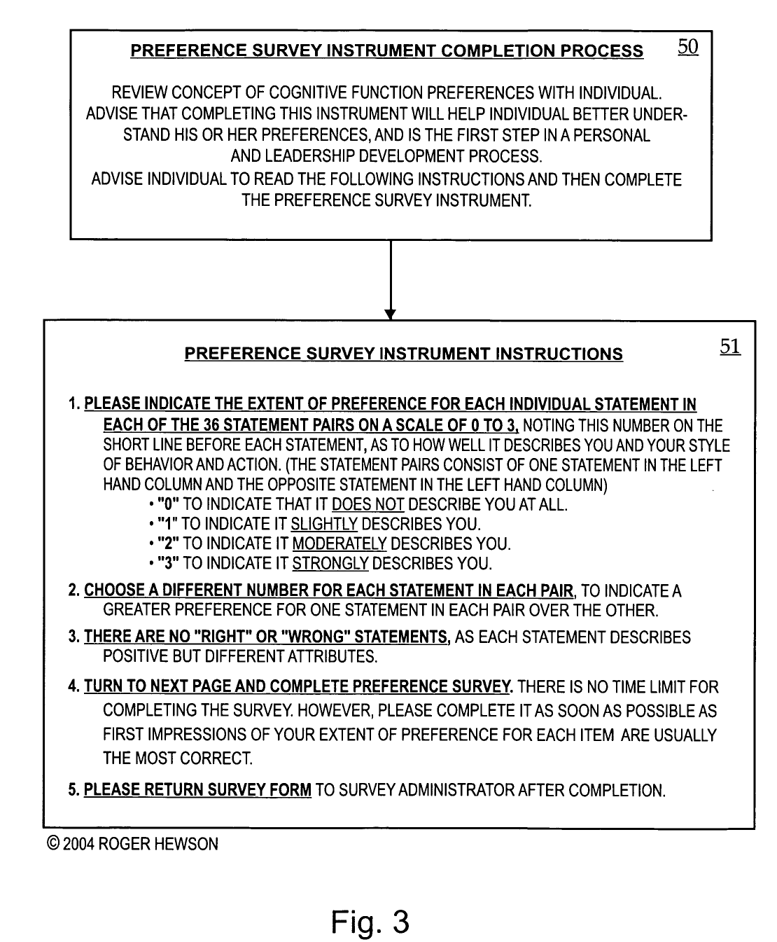

The Preference Survey Instrument Instructions are referred to now in FIG. 3 of the drawings, illustrating a flow chart instructing an individual on completing a Preference Survey Instrument. They are detailed further as follows:

(a) Block 50 represents reviewing the concept of cognitive function preferences with individual, advising the individual that completing this instrument will help individual better understand his or her preferences, and is the first step in a personal and leadership development process. The individual is then advised to indicate the extent of their preferences for each statement as he or she truly sees and knows themselves today, as this will give the most precise indicator of their natural set of preferences and interests. If they complete this survey accurately and correctly, it will identify the way others know them. If they record their preferences it as they would like to be, they will end up with an inaccurate and confusing report that will be very different from their true personality. The individual is further advised to read the specific instructions represented in block 51 and then to complete the Preference Survey Instrument.

(b) Block 51 represents the Preference Survey Instrument Instructions, requesting the individual to evaluate each item on how well it reflects the individual's preferred way of working and relating to others on a scale from 0 to 3, with 0 indicating not at all and 3 indicating a very strong preference. There is an additional request that one item in the pair receive a higher evaluation than the other to indicate a higher magnitude of preference for one item in each pair. The individual is advised that there is no time limit for completing this survey, and the survey form should be returned to the administrator on completion.

The Preference Survey Instrument

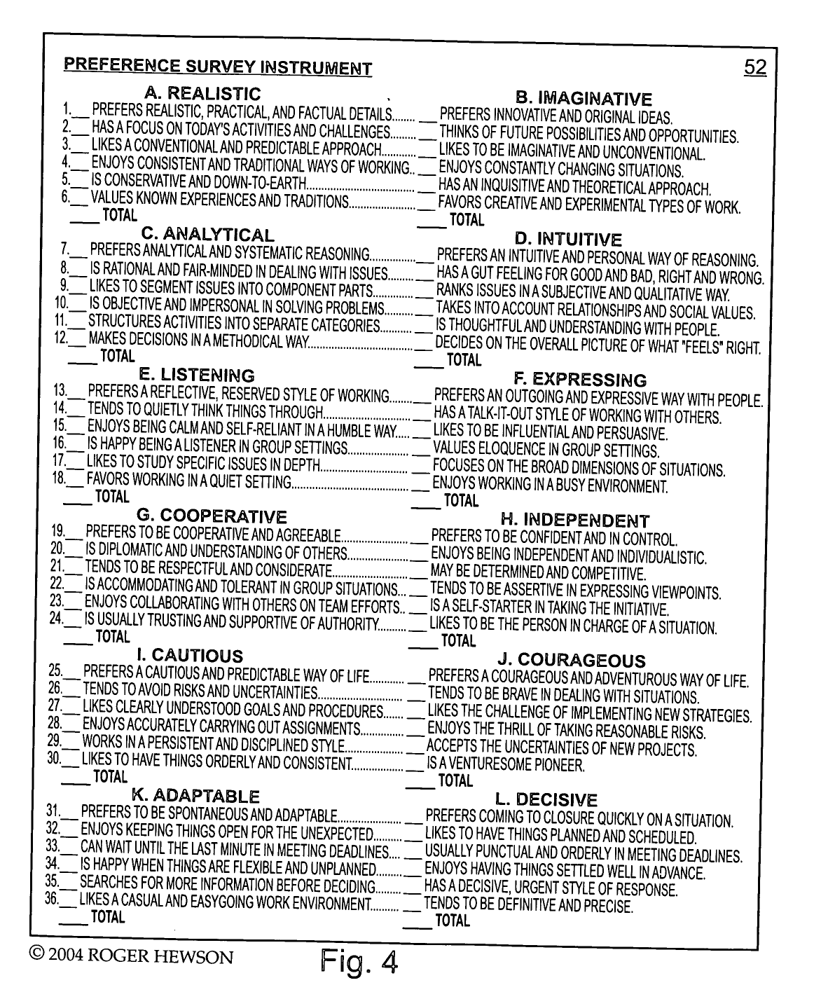

A Preference Survey Instrument is referred to now in FIG. 4 of the drawings. A diagram is presented in block 52 illustrating a sample preference survey instrument to establish an individual's extent of preference for each of the twelve cognitive functions, with the intent of establishing a greater preference for one function in each pair over the other.

(a) In this sample instrument, the statements relative to a specific function are grouped together to provide a clear illustration of the methodology of this survey concept. There are six trait statements for each of the functions, and each statement in the left column is matched with a complementary and polar-opposite statement in the right column. The individual is asked to evaluate one of the trait statements in each pair higher than the other to indicate a greater preference for this trait over the other.

(b) This sample survey instrument has been selected from a group consisting of: (a) this example using preference statements, an instrument using related pairs of individual words related to traits of each of the twelve cognitive functions, (b) an instrument composed of pairs of questions, and (c) a more casual scoring method of simply observing trait behaviors relative to each of the twelve functions to establish an early “speed-reading” impression of another individual's preferences. Further, the survey instrument may have an obvious listing of traits grouped together related to each function, or it may have a “blind” character where the trait pairs are listed in a random way to make their connection with a specific function less obvious. In this latter type of instrument, a legend or template is needed to score each pair relative to the cognitive functions they represent. Each of the survey instruments in this group may have any number of paired survey items, with this example using six items to evaluate for each cognitive function. The total of preference points for each of the twelve functions is determined by adding up the points awarded to each item referring to that cognitive function.

(c) The survey instrument may be constructed to indicate a magnitude of preference for each of the twelve cognitive functions by an individual reporting on any one of a group consisting of his or her: (a) own personal preferences for each function; (b) perspective of how others expect he or she should prefer each function; (c) observed preferences of another individual or entity based on actions and behaviors; (d) perspective on the required preferences for a specific role or employment position; and (e) view of the cultural preferences of a group, organization, geographic region, or country.

The Preference Survey Report

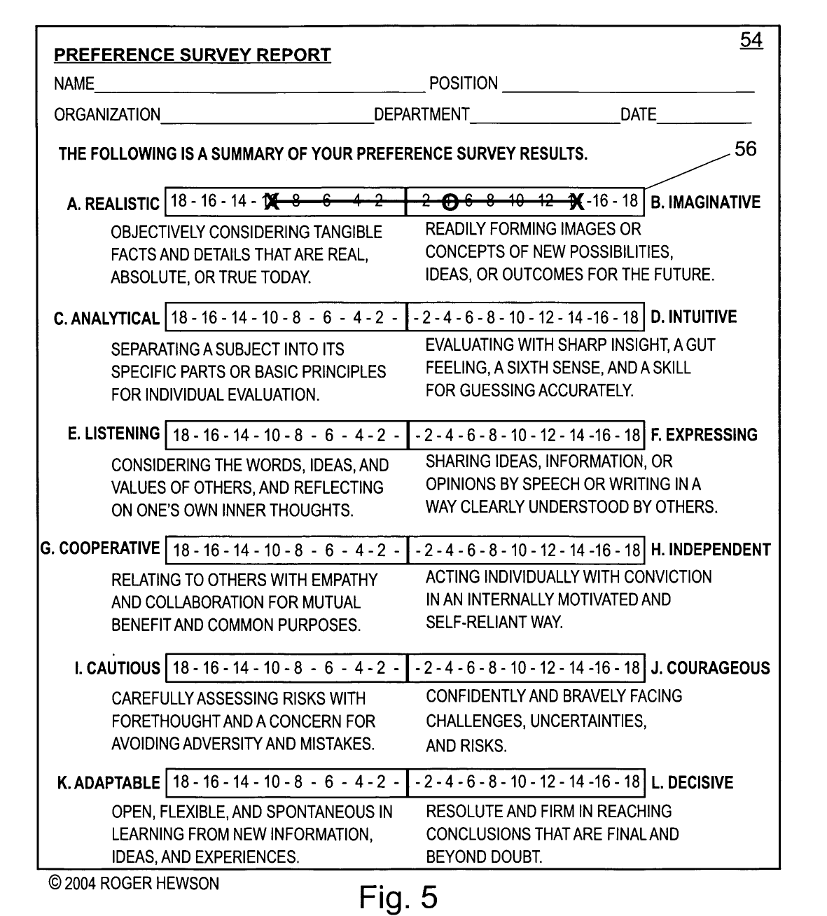

A Preference Survey Report is referred to now in FIG. 5 of the drawings. This illustrates one example of a sample form showing the individual's preference points for each function as represented in block 54. It is further described as follows:

(a) Block 56 represents a horizontal reporting bar showing a points scale for two opposing cognitive functions with a scale of O to 18 for each function and with the zero point in the middle of the bar. The numerical total of preference points for an individual function is indicated by an “X” placed on the scale number for each function representing the total of preference points awarded to that function. The two scoring “X” indicators are connected with a bold solid line for graphic clarity. This report system is repeated on the other five reporting bars for each of the other five pairs of functions.

(b) The magnitude of preference for one function in the pair over the other is calculated by subtracting the points awarded to the less preferred function in each pair from the total awarded to the more preferred function in each pair. This magnitude of preference for one function in the pair over the other is recorded by “O” placed at this numerical position on the scale of the more preferred function as represented in this block 56.

(c) In the scoring example represented in block 56, preference points of 10 for the Reality function and 14 for the opposite Imagination function are shown, with the greater preference for Imagination of four preference points indicated by the “0” at the number 4 on the scale.

Establishing the Preferences of an Individual

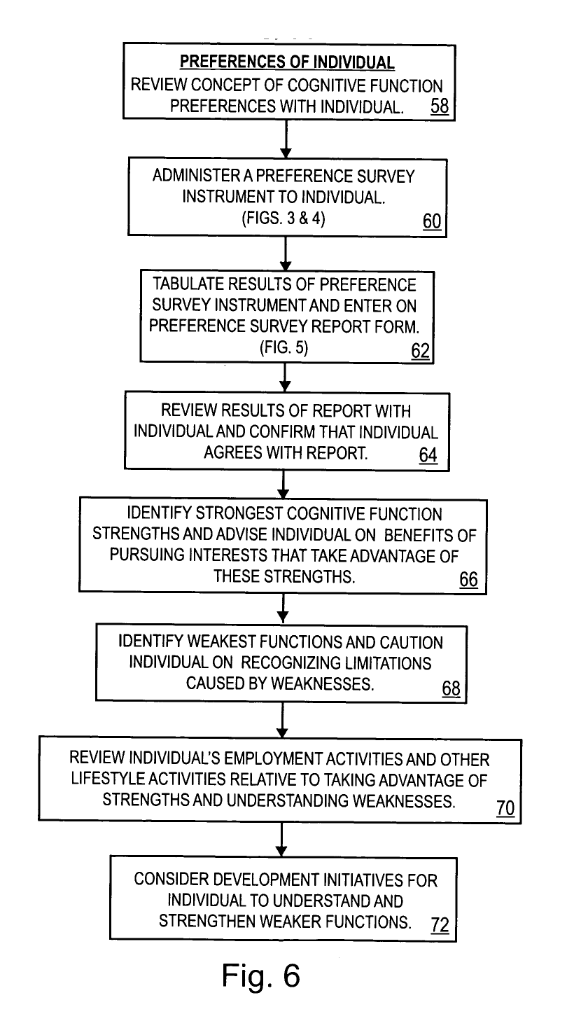

Establishing the preferences of an individual, and using that information for developmental purposes, is referred to now in FIG. 6 of the drawings. This process is further described as follows:

(a) Block 58 represents the step of reviewing the concept of the twelve cognitive functions of this invention, and for the natural preference all individuals have for one function in each pair over the other.

(b) Block 60 represents the step of explaining the Preference Survey Instrument instructions (FIG. 3) to the individual and providing the survey instrument (FIG. 4) for the individual to complete.

(c) Block 62 represents the step of evaluating the Preference Survey Instrument statement items (FIG. 4), and placing the evaluation numbers on a copy of the Preference Survey Report Form (FIG. 5).

(d) Block 64 represents the step of reviewing the report form (FIG. 5) with the individual, and confirming that the individual believes that this report is a true indication of his or her preferences by the process of further reviewing the characteristics and traits of each cognitive function. This step further represents reviewing the concept of pairs of functions, left-brain and right-brain style characteristics, and sectors of cognition.

(e) Block 66 represents the step of identifying the strongest cognitive function preferences of the individual, and explaining that pursuing activities that honor those specific stronger cognitive functions will be more motivating and rewarding.

(f) Block 68 represents the step of identifying the weaker cognitive function preferences of the individual, and explaining that pursuing activities that minimize the need for strengths in these specific weaker cognitive functions will be more motivating and rewarding.

(g) Block 70 represents the step of reviewing individual's employment activities and lifestyle activities relative to taking advantage of strengths and understanding weaknesses.

(h) Block 72 represents the step of considering development initiatives to understand and strengthen weaker functions. The individual is advised to pursue ways to develop an understanding and competence in these less preferred functions to avoid their becoming liabilities.

Establishing the Preferences of Individuals in a Group

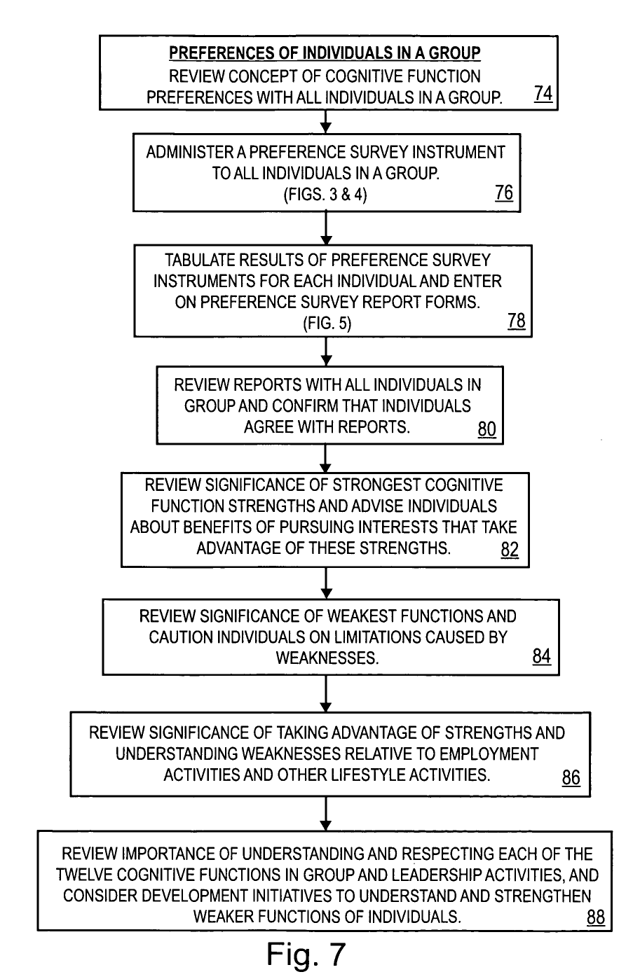

Establishing the preferences of individuals in a group, and using that information for developmental purposes, is referred to now in FIG. 7 of the drawings. This is a very similar system and method to that illustrated in FIG. 6, but using the sequence of steps in a group setting and for group development purposes. This is described further as follows:

(a) Block 74 represents the step of reviewing the concept of the twelve cognitive functions of this invention to individuals in a group, and for the natural preference all individuals have for one function in each pair over the other.

(b) Block 76 represents the step of explaining the Preference Survey Instrument Instructions (FIG. 3) to the individuals and providing the survey instrument (FIG. 4) for the individuals to complete.

(c) Block 78 represents the step of evaluating preference for each statement on the Preference Survey Instruments (FIG. 4) for each individual and placing the evaluation numbers on copies of the Preference Survey Report form (FIG. 5).

(d) Block 80 represents the step of reviewing report forms (FIG. 5) with individuals in the group, and confirming that individuals believe that this report is a true indication of his or her preferences by the process of further reviewing the characteristics and traits of each cognitive function. This step further represents reviewing the concept of pairs of functions, left-brain and right-brain style characteristics, and sectors of cognition.

(e) Block 82 represents the step of identifying the process of identifying the strongest cognitive function preferences of individuals as indicated on each report form, and explaining that pursuing activities that honor those specific stronger cognitive functions will be more motivating and rewarding.

(f) Block 84 represents the step of identifying the weaker cognitive function preferences of the individual, and explaining that pursuing activities that minimize the need for strengths in these specific weaker cognitive functions would be more motivating and rewarding. Individuals are advised to pursue ways to develop an understanding and competence in these less preferred functions to avoid their becoming liabilities.

(g) Block 86 represents the step of reviewing employment activities and lifestyle activities relative to taking advantage of strengths and understanding weaknesses.

(h) Block 88 represents the step of reviewing the importance of understanding and respecting the need for competence in each of the twelve cognitive functions in group and leadership activities, and to consider development initiatives to understand and strengthen weaker functions of individuals.

Establishing the Preferences of Another Entity

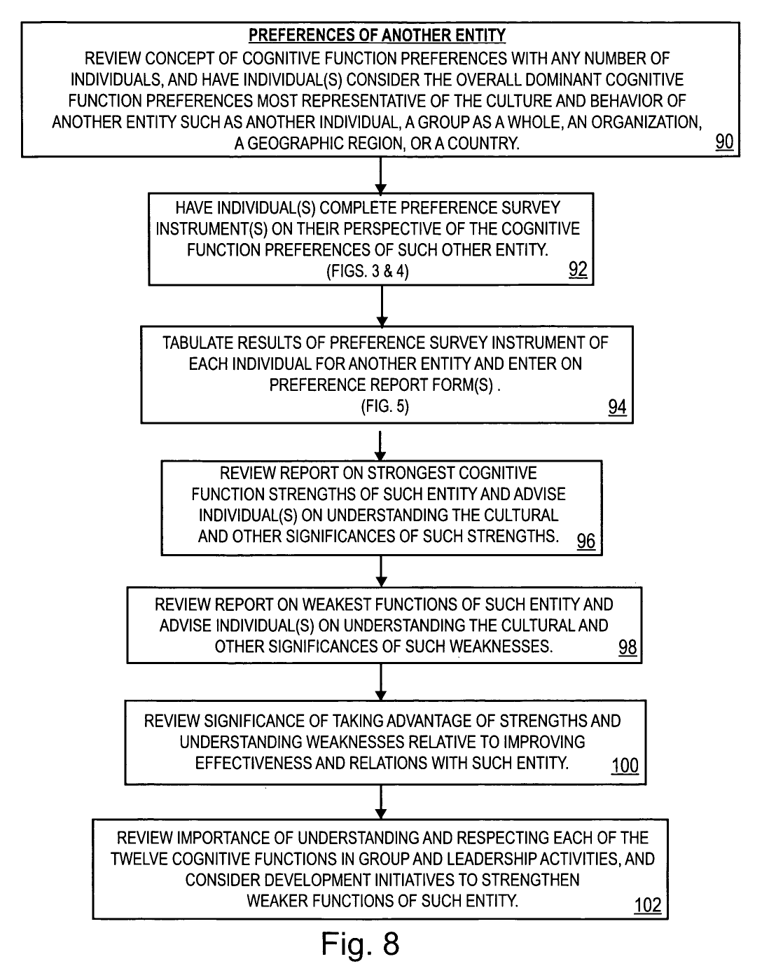

Establishing the preferences of another entity, and using that information for developmental purposes, is referred to now in FIG. 8 of the drawings. This is a very similar system and method to that illustrated in FIGS. 6 and 7 of the drawings, but using the sequence of steps to determine the cognitive preferences of other entities and to use this knowledge for individual and group development purposes. This is described further as follows:

(a) Block 90 represents the step of reviewing the concept of cognitive function preferences with any number of individuals, and have individual(s) consider their perception of the level of preference for each of the twelve cognitive function of another entity based on observations of the actions and behavior of this other entity, with such other entity being another individual, a group as a whole, an organization, a geographic region, or a country.

(b) Block 92 represents the step of explaining the Preference Survey Instrument Instructions (FIG. 3) to the individual(s), and then providing the Preference Survey Instrument (FIG. 4) for the individuals to complete on their perspective of the cognitive function preferences of such other entity.

Block 94 represents the step of evaluating preferences for each of the statements of the Preference Survey Instrument(s) (FIG. 4) for each individual(s) perspective of the cognitive function preferences of another entity, and placing the preference numbers on copies of the Preference Survey Report form (FIG. 5).

(e) Block 96 represents the step of identifying the process of identifying the strongest cognitive function preferences of entities as indicated on the report form(s), and advise individual(s) on understanding the cultural significance and personality features of such strengths. This step further represents reviewing the concept of pairs of functions, left-brain and right-brain style characteristics, and sectors of cognition.

(f) Block 98 represents the step of identifying the weaker cognitive function preferences of the entity, and advise individual(s) on understanding the cultural significance and personality features of such weaknesses.

(g) Block 100 represents the step of reviewing the significance of taking advantage of strengths and understanding weaknesses relative to improving effectiveness and relations with such entity and working more effectively with such entity in group settings.

(h) Block 102 represents the step of reviewing the importance of understanding and respecting each of the twelve cognitive functions in group and leadership activities, and of considering development initiatives to strengthen weaker functions of such entity or to avoid weaker functions of entity to keep them from becoming a liability.

Utilizing Two Pairs of Cognitive Functions of this Invention with Unrelated Methods

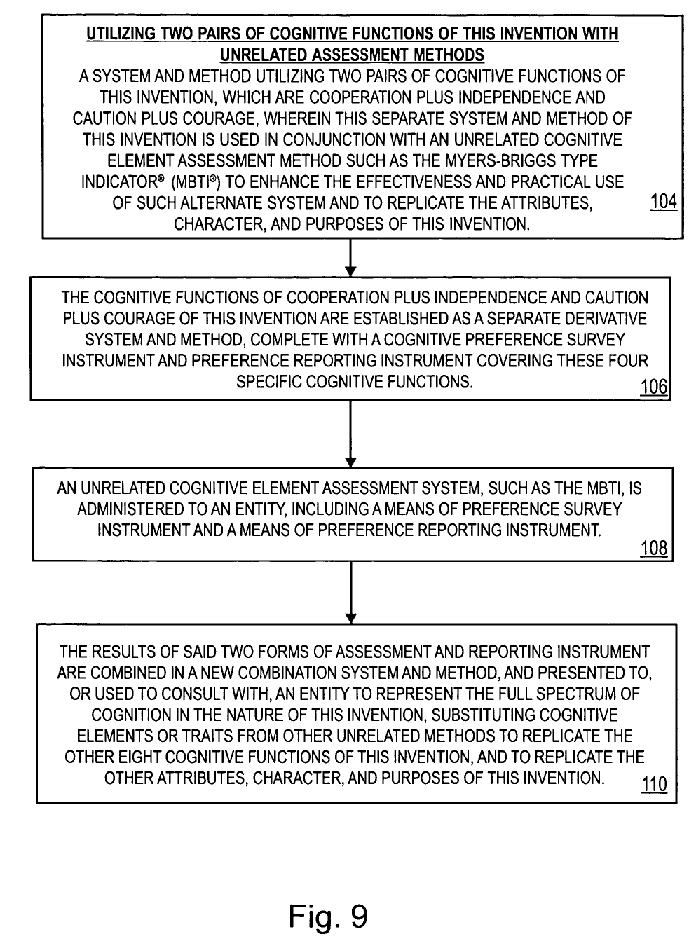

Utilizing two pairs of cognitive functions of this invention with unrelated assessment methods is referred to now in FIG. 9 of the drawings. This process of combining the virtues of this invention with other unrelated but commonly used assessment methods is a way of utilizing this invention to bring substantial added features and advantages to other assessment methods. It is further described as follows:

(a) Block 104 represents the concept of a system and method utilizing two pairs of cognitive functions of this invention, which are Cooperation plus Independence and Caution plus Courage, wherein this separate system and method of this invention is used in conjunction with an unrelated cognitive element assessment method such as the Myers-Briggs-Type Indicator® (MBTI®) to enhance the effectiveness and practical use of such alternate system and to replicate the attributes, character, and purposes of this invention.

(b) Block 106 represents the step whereby the cognitive functions of Cooperation plus Independence and Caution plus Courage of this invention are established as a separate derivative system and method. This separate system and method utilizes a cognitive preference survey instrument and preference reporting instrument based on the preference survey and reporting principles of FIGS. 3, 4, and 5 of this invention but covering just these four specific cognitive functions.

(c) Block 108 represents the step whereby an unrelated cognitive element assessment system, such as the MBTI, is administered to an entity, including a means of preference survey instrument and a means of preference reporting instrument.

(d) Block 110 represents the step whereby the results of the two forms of assessment and reporting instrument are combined in a new system and method combining this invention with another unrelated form of assessment system. This combination of the two systems and methods is then presented to, or used to consult with, an entity to represent the full spectrum of cognition in the nature of this invention, substituting cognitive elements or traits from other unrelated methods. It has the intent to replicate the other eight cognitive functions of this invention and their features, and the intent to replicate the other attributes, character, and purposes of this invention.

The Four Quadrants of Reasoning as a Separate Development System

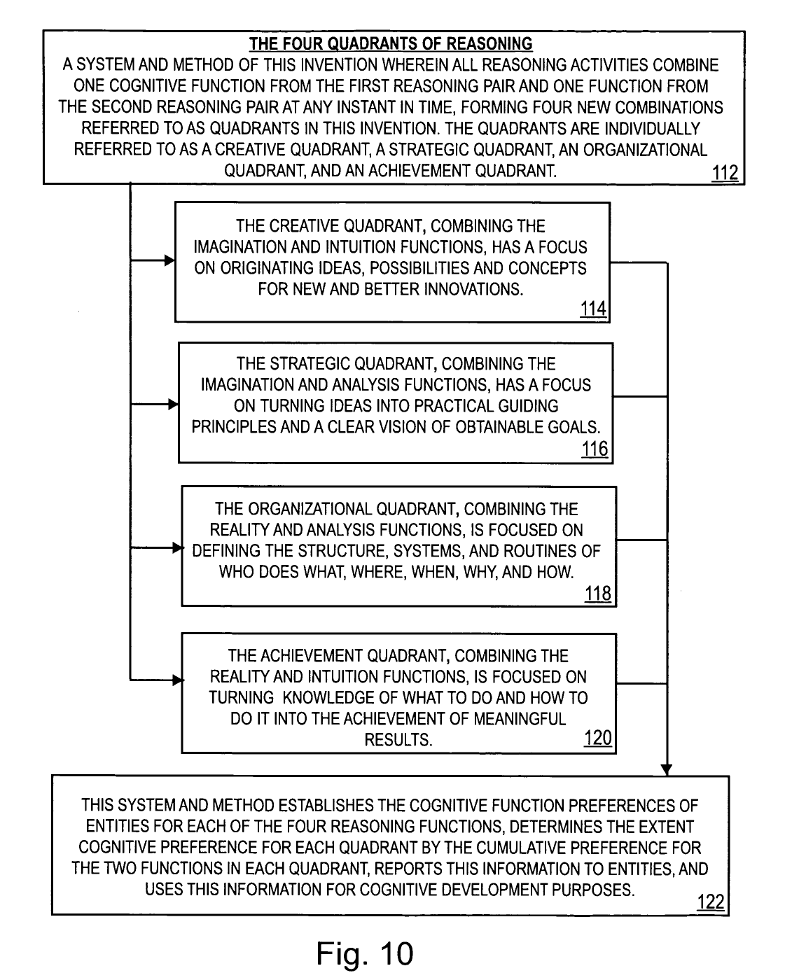

Using the four quadrants of Reasoning as a separate executive development system and method is referred to now in FIG. 10 of the drawings. All Reasoning activities combine one cognitive function from the first Reasoning pair and one function from the second Reasoning pair at any instant in time, forming four combinations that we call “quadrants,” as referred to in block 112. The quadrants are named the Creative Quadrant, the Strategic Quadrant, the Organizer Quadrant, and the Achiever Quadrant. Effectiveness in each quadrant is necessary in turning ideas into tangible results. This quadrant format is a very helpful tool in using this invention to speed-read individual and executive activities to assure all four quadrants of Reasoning are used effectively in turning ideas into results. It is further described as follows:

(a) Block 114 represents the Creative Quadrant, combining all the features and attributes of our Imagination (B) and Intuition (D) functions, where ideas, possibilities and concepts are developed for new and better innovations.

(b) Block 116 represents the Strategic Quadrant, combining all the features and attributes of our Imagination (B) and Analysis (C) functions, where the most practical and usable innovations from the Creative Quadrant activities are developed further into guiding principles and a clear vision of obtainable goals.

(c) Block 118 represents the Organizational Quadrant, combining all the features and attributes of our Reality (A) and Analysis (C) functions, where the vision and goals of the Strategic Quadrant are developed further into the structure, systems, and routines of who does what, where, when, why, and how.

(d) The Achievement Quadrant, represented in block 120, combining all the features and attributes of our Reality (A) and Intuition (D) functions, is where the structure, systems and routines of the Organizational Quadrant, with knowledge of what to do and how to do it, is converted into the achievement of meaningful results.

This separate system and method utilizes a preference survey instrument and a preference survey report instrument, referred to in block 122, based on the preference survey and reporting principles illustrated in FIGS. 3, 4, and 5 of this invention but covering just these four specific cognitive functions.

This quadrant format is a very practical system and method in using this invention to speed-read the nature of individual Reasoning activities, and to assure all four quadrants of Reasoning are used appropriately in turning ideas into results, further represented in block 122. Thoroughness in using each of the four quadrants of Reasoning is necessary in all truly effective leadership activities. It is helpful to think of an organizational office setting where there are four identical conference rooms next to each other along a corridor, with names over the doors indicating them as the Creative room, the Strategic room, the Organizing room, and the Achievement room.

(a) When a group meets in the Creative room, again referring to block 114, all individuals must concentrate solely on using their Imagination and Intuition cognitive functions in combination to come up with creative new ideas, possibilities, and concepts for improving the organization and its products. Behaviors associated other combinations of the four Reasoning functions are not allowed in this room at any time.

(b) Later, when the same group meets in the Strategic room, again referring to block 116, all the same individuals must concentrate solely on using their Imagination and Intuition cognitive functions in combination to come up with ways to turn the most practical and usable of the Creative Quadrant innovations into guiding principles and a clear vision of obtainable goals. Behaviors associated other combinations of the four reasoning functions are not allowed in this room at any time.

(c) Still later, when the same group meets in the Organizing room, again referring to block 118, all the same individuals must concentrate solely on using their Reality plus Analysis cognitive functions in combination to develop the structure, systems, and routines of who does what, where, when, why, and how to achieve the Strategic Quadrant vision and goals. Behaviors associated other combinations of the four Reasoning functions are not allowed in this room at any time.

(d) Even still later, when the same group meets in the Achievement room room, again referring to block 120, individuals must concentrate fully on using only their Reality plus Intuition cognitive functions in combination to turn knowledge from the Organizer Quadrant of what to do and how to do it into the achievement of meaningful results. Of course, in most organizational settings, additional individuals will be brought in at this stage to increase the ability to produce the needed volume of results. Behaviors associated with other combinations of the four Reasoning functions may be needed from time to time, as unusual and different situations occur. It is then appropriate to return to the other quadrant conference rooms, in mind if not in body, to use appropriate Reasoning function combinations of the other quadrants to deal with the situation.

The Cognitive Function Application Code.

The following code of further conditions and rules governs the understanding and application of the concept of twelve cognitive functions in individual and group cognitive development programs. This code is especially useful in understanding the proper use of the cognitive function concept and interaction of the functions with each other.

(a) All cognitive activities and behaviors are: (a) defined by one of the twelve cognitive functions of this invention; (b) are a subset of one of the functions such as trust as a subset of Cooperation: (c) or are a combination of two or more functions such as Imagination and Intuition combining to define Creativity.

(b) Only one function in a pair can combine with one function in any of the other five pairs at a given instant in time, although any combination can change instantly to another such combination.

(c) An individual's preference set identifies their core competencies of interests and preferences at a given point in time, formed by their genetic heritage plus experiences in life to date. It becomes the driving force defining the actions and behaviors that govern the way individuals lead their lives. All individuals naturally perform best, are more comfortable, and have more energy with work that takes advantage of their preferred functions. They also naturally feel an increased sense of anxiety, stress, and lower levels of energy when obliged to do work that requires their less preferred functions.

(d) Individuals are able to use only one function in a pair at a time. With the complementary but polar-opposite attributes of each function in a pair, only one function in a pair can be used at any given instant in time as they are mutually exclusive in nature, just as you cannot walk both east and west at the same time. However, an individual can instantly oscillate back and forth between left and right functions in a pair to bring the virtue of opposite functions into play.

(e) It is most appropriate to use the slower left-brain style function in each pair first, to prepare for the most appropriate use of the faster right-brain style partner next. If an individual has a natural preference for the right-brain style function in a pair, he or she will instinctively open the thought process with this function. However, it is most effective if he or she quickly cycles back to the primary left-brain style function of the pair to allow it to do its work, before returning to the preferred right-brain style partner. Knowing the Reality of a situation first, before Imagining ways to improve the situation, illustrates this logical sequence.

(f) An individual's preference set of one preferred function in each pair is a filter that forms a bias that affects all his or her thoughts and actions. An individual's natural preference set can easily bias his or her judgment and perception of others. It is common, without knowledge of the twelve functions, for individuals to assume others are wrong if others view the world differently with their own personal bias due to their own unique set of preferences.

(g) An individual's preferences often change with the situation. Each person will have a natural preference for only one function in each pair but will often use its opposite in situations of a different nature. It is important to learn to identify the normal actions and behaviors associated with each function, both personally and in others. This gives individuals the ability to instantly speed-read the proper or improper use of each function in a specific situation.

(h) It is not appropriate to rigidly classify people into types or categories according to the profile of their primary set of preferences, as this assumes they will always behave in accordance with the norms for their usual type. Individuals will behave very differently—shifting to their less preferred functions—to deal with the many varying situations encountered during a typical day in relating to different people and situations. This will be especially true during high stress situations.

(i) Memories of all experiences are stored with both facts and feelings about the situation. Every experience individuals have had in their lives is stored in their subconscious databank with both an objective set of left-brain style facts and a subjective right-brain style evaluation of its virtues. An individual recalling a frightening experience in his or her youth will remember both the details and how afraid he or she felt. When thinking of an especially pleasant experience, individuals will recall the joy of the moment as well as the facts.

(j) Individuals all have different levels of competence and preference among the twelve cognitive functions that may be classified as strengths, non-strengths and weaknesses. A strength is when the combination of talent, skill, and preference provide great competence in using the function. A non-strength is when an individual recognizes his or her limitations in a function, finds someone else to cover its requirements, or avoids relying on it in his or her work. A weakness is when an individual is unaware of his or her limitations in a function, often using it inappropriately or in place of the opposite function.

(k) The extreme use of any of the twelve cognitive functions can become a negative. When any one function in a pair is strongly preferred over its opposite, it becomes overly dominant and overshadows its opposite partner in the pair. This forces the polar-opposite function into a passive and inadequate role, greatly reducing an individual's ability to properly use this function.

(l) Specialists can often excel in their unique area of expertise relying on their preferred set of functions without needing competence in each of the noted cognitive functions. The majority of people in any organization can succeed admirably in their roles as specialists, relying on talents and capabilities in some of the twelve cognitive functions. A business would be idealistic in thinking it could seek out and employ only individuals with proven capability in each of the functions. Very few people are talented experts in each and every one of them. Specialists will be happiest and most productive when job requirements match their true natural talents in their preferred areas of interest.

(m) Managers who administer the successful outcomes of established initiatives must at least be aware of, and familiar with, the virtues of each of the functions. This is necessary in order for them to be able to honor and respect the differing preference interests and abilities of the individual specialists they supervise. The goal in managing specialists is clearly identifying and building on each person's natural abilities in his or her preferred functions, and neutralizing non-strengths to avoid having them become weaknesses that hinder performance.

(n) Leaders, to be truly effective in the full spectrum of necessary leadership activities, require an adequate level of understanding and competence in all of the twelve functions in addition to exceptional talents in their own preferred set of six functions. Each function is indispensable in the leadership process. Leaders must have the courage to acknowledge the strengths of their personal preference set of innate preferences—and also their weaknesses—and to accept and respect that others will have differing but complementary ways of thinking.

Caution. While personality assessment systems and methods are helpful tools in understanding people, no self-reported survey of preferences should ever be used as the basis for hiring, firing, promoting, or rewarding any person. A highly motivated individual with the “wrong” profile for a job will often far outperform a less motivated individual with the “right” profile for the given activity.

A Leadership Development Program.

This invention is practical as an executive development system and method, and as a leadership development process, by greatly facilitating the building of strong management capabilities in an organization. The most important competitive advantage an organization can have is the ability to use human brainpower effectively, whether people are working alone or in cooperation with others. This invention may be used in the following primary ways:

(a) Defining an individual's profile of six preferred cognitive functions will guide him or her in building on strengths and improving abilities to deal with non-strengths and weaknesses among the twelve functions. By identifying any possible inadequately developed cognitive functions, an individual can minimize their becoming an obstacle to success. Their profile of six preferences will also help individuals understand the “filter,” or bias, each may have in evaluating the interests and abilities of others.

(b) Identifying the preferences of each individual in an organization provides a way to for individuals to choose specific projects or job assignments where his or her unique “specialist” cognitive function abilities will be most effective.

(c) Spotting those few exceptional well-rounded individuals with competencies in most or all of the functions is helpful in identifying those best suited for top leadership roles.

(d) Forming project teams with individuals having the diverse cognitive function talents and capabilities needed ensures the team will meet the requirements of the assignment.

(e) Surveying the cognitive function profile of top leaders and key associates in an organization will identify the overall dominant cognitive function preferences and culture of the organization, and can help determine if this set of preferences matches the needs of the organization.

(f) Developing a “learning organization” focus in a company encourages the continual learning of ways to improve each person's competence in all of the twelve cognitive functions.

(g) Understanding how customers make their purchase decision using both objective left-brain style functions to evaluate features and subjective right-brain style functions to evaluate benefits improves the ability to satisfy customers.

(h) Relations with people from other cultures and geographic regions can be improved by recognizing the specific cognitive function preferences that are highly valued as the cultural norm in their societies.

(i) It is generally acknowledged that it is very difficult to change a person's overall character. However, all individuals are able to learn and grow in their abilities to use each of the cognitive functions, and to learn new behaviors that enhance their ability to be more effective with our natural talents. Individuals also can develop higher levels of competency in their less preferred functions so that these functions can be relied on when the situation warrants.

### CONCLUSIONS, RAMIFICATION, AND SCOPE OF INVENTION

This invention provides obvious advantages and features to aid individuals in improving their cognitive abilities and enjoying increased success in their lives. It is a universal way to understand the full spectrum of cognition, and is a practical system and method to incorporate into daily activities in individual situations, in group situations, and in organizations. While the above descriptions contain many specific details, these should not be construed as limitations on the scope of the invention. There are many possible variations of the preference survey instrument form, the preference survey report form, and ways to present information on the twelve functions of this invention. Also, many other ways of using, interpreting, and applying this invention are possible. Accordingly, the scope of this invention should be determined not by the embodiment(s) illustrated, but by the appended claims and their legal equivalents.

The Claims

While the present invention has been described with particular reference to certain embodiments of the system and method of the invention, it is to be understood that it includes all reasonable equivalents thereof as defined by the following appended claims.

1) A system and method for understanding and developing the cognitive abilities of an entity comprising the step of identifying the cognitive architecture of said entity as the sum of twelve cognitive functions wherein:
(a) said twelve cognitive functions are Reality, Imagination, Analysis, Intuition, Listening, Expressing, Cooperation, Independence, Caution, Courage, Adapting, and Deciding;
(b) the general nature of each of said functions matches its American dictionary definition; and
(c) each of said functions may be referred to in the form of a noun, verb, adjective, and other equivalent word defining the character of said function.

2) The system and method as claimed in claim 1 further comprising the step of matching said twelve cognitive functions in pairs of complementary left-brain style and right-brain style functions wherein:
(a) said pairs consist of said functions of Reality with Imagination, Analysis with Intuition, Listening with Expressing, Cooperation with Independence, Caution with Courage, and Adaptability with Decisiveness;
(b) said left-brain style functions consisting of said functions of Reality, Analysis, Listening, Cooperation, Caution, and Adaptability are associated with a slower, objective, conscious, and divergent left-brain character of serial cognitive processing; and
(c) said right-brain style functions consisting of said functions of Imagination, Intuition, Expressing, Independence, Courage, and Decisiveness are associated with a faster, subjective, subconscious, and convergent right-brain character of parallel cognitive processing.

3) The system and method as claimed in claim 1 further comprising the step of associating sets of said cognitive functions with Reasoning, Relating, and Action sectors of cognition wherein:
(a) said cognitive functions of Reality, Imagination, Analysis, and Intuition are associated with said Reasoning sector of cognition;
(b) said functions of Listening, Expressing, Cooperation, and Independence are associated with said Relating sector of cognition; and
(c) said functions of Caution, Courage, Adaptability, and Decisiveness are associated with said Action sector of cognition.

4) A system and method comprising the step of assessing the extent of preference of an entity for each of twelve cognitive functions using a preference survey instrument wherein:
(a) said twelve cognitive functions are paired in six pairs consisting of Reality with Imagination, Analysis with Intuition, Listening with Expressing, Cooperation with Independence, Caution with Courage, and Adapting with Deciding;
(b) said preference survey instrument uses an assessment means to establish an extent of preference of said entity for each of said twelve functions on a scale of low to high; and
(c) said assessment means consists of evaluating any number of cognitive trait items to indicate a degree of preference of said entity for each of said trait items that are individually related to each of said twelve functions.

5) The system and method as claimed in claim 4 further comprising the step of matching said twelve cognitive functions in said pairs of complementary left-brain style functions and right-brain style functions wherein:
(a) said left-brain style functions consist of said functions of Reality, Analysis, Listening, Cooperation, Caution, and Adaptability are associated with a slower, objective, conscious, and divergent left-brain character of serial cognitive processing; and
(b) said right-brain style functions consist of said functions of Imagination, Intuition, Expressing, Independence, Courage, and Decisiveness are associated with a faster, subjective, subconscious, and convergent right-brain character of parallel cognitive processing.

6) The system and method as claimed in claim 4 further comprising the step of associating four of said cognitive functions with each of the Reasoning, Relating, and Action sectors of cognition wherein:
(a) said functions of Reality, Imagination, Analysis, and Intuition are associated with said Reasoning sector of cognition;
(b) said functions of Listening, Expressing, Cooperation, and Independence are associated with said Relating sector; and
(c) said functions of Caution, Courage, Adaptability, and Decisiveness are associated with said Action sector.

7) The system and method as claimed in claim 4 further comprising the step of using a preference survey instrument with any number of complementary statement pairs of said left-brain style and right-brain style functions wherein:
(a) each of said statement pairs is associated with traits specific to each of the two of said functions in one of said pairs;
(b) each of said statements within said statement pairs is configured to represent one of said traits related to one of said functions of this invention; and
(c) each of said individual statement items may be selected from a group consisting of a descriptive word, a phrase, a question, and a behavior.

8) The system and method claimed in claim 4 further comprising the step of providing a report on said preference survey instrument identifying said entity's greater preference for one of said cognitive functions in each of said six pairs of functions and said entity's lesser preference for one of said cognitive functions in each of said six pairs of functions.

9) The system and method as claimed in claim 4 further comprising the step of using said preference survey instrument assessment to provide information to:
(a) guide said entity in recognizing said entity's greater preference for using one of said functions in each of said pairs;
(b) recognize said entity's lesser preference for using one of said functions in each of said pairs;
(c) identifying said entity's extent of preference for one of said functions over the other in each of said six pairs of said functions; and
(d) using said information to better understand the naturally preferred functions of said entity, and to enhance the development of cognitive capabilities of said entity.

10) A system and method comprising the utilization of two pairs of cognitive functions to enhance the attributes and effectiveness of other unrelated cognitive element assessment means wherein:
(a) said pairs of functions are Cooperation plus Independence and Caution plus Courage;
(b) each of said four functions may be referred to in the form of a noun, verb, adjective, and other equivalent word describing said function;
(c) said system and method is utilized in conjunction with unrelated cognitive element assessment means to enhance the effectiveness and practical use of said unrelated means;
(d) the cognitive elements of said unrelated cognitive element systems are substituted for any of Reality, Imagination, Analysis, Intuition, Listening, Expressing, Adapting, and Deciding cognitive functions; and
(e) the intent is to replicate the unique and original attributes of any of said functions and the comprehensive nature and features of said combination of said twelve functions and said equivalents.

11) The system and method claimed in claim 10 further comprising the step of using any cognitive elements of the Myers-Briggs Type Indicator® (MBTI®) method with the purpose of approximately substituting said elements for any number of said twelve cognitive functions wherein:
(a) said substitutions may include substituting said Reality function of this invention with a sensing element of MBTI, substituting said Imagination with intuition, substituting said Analysis with thinking, substituting said Intuition with feeling, substituting said Listening with introversion, substituting said Expressing with extraversion, substituting said Adaptability with perceiving, and substituting said Decisiveness with judging;
(b) with the intent of using other labels, names and elements as substitutes for any of said twelve cognitive functions; and
(c) with the intent to replicate the unique and original attributes of any of said twelve functions and the comprehensive nature and features of said combination of said twelve functions.

12) The system and method as claimed in claim 10 further comprising the step of aligning said substitute elements of said unrelated cognitive assessment means to replicate the concept of matching said substitutions with said twelve cognitive functions in pairs of complementary left-brain style and right-brain style functions wherein:
(a) said functions and said substitutes replicate the concept of forming pairs of said functions of Reality with Imagination, Analysis with Intuition, Listening with Expressing, Cooperation with Independence, Caution with Courage, and Adaptability with Decisiveness;
(b) said functions and said substitutes replicate the concept of identifying left-brain style functions similar to said functions of Reality, Analysis, Listening, Cooperation, Caution, and Adaptability and associating them with a slower, objective, conscious, and divergent left-brain character of serial cognitive processing; and
(c) said functions and said substitutes replicate the concept of identifying right-brain style functions similar to said functions of Imagination, Intuition, Expressing, Independence, Courage, and Decisiveness and associating them with a faster, subjective, subconscious, and convergent right-brain character of parallel cognitive processing.

13) The system and method claimed in claim 10 further comprising the step of aligning said substitute elements of said unrelated methods to replicate the concept of associating said substitutions for said twelve cognitive functions of said invention with Reasoning, Relating, and Action sectors of cognition wherein:
(a) said elements substituted for said functions of Reality, Imagination, Analysis, and Intuition are associated with said Reasoning sector of cognition;
(b) said substituted elements for said functions of Listening, Expressing, Cooperation, and Independence are associated with said Relating sector;
(c) said substituted elements for said functions of Caution, Courage, Adaptability, and Decisiveness are associated with said Action sector; and
(d) with the intent to replicate the comprehensive nature and features of said combination of twelve cognitive functions.

14) The system and method as claimed in claim 10 further comprising the step of assessing the extent of preference of an entity for each of said twelve cognitive functions, and any said substitute for any of said functions, using a preference survey instrument wherein:
(a) said preference survey instrument uses an assessment means to establish a degree of preference of said entity for each of said twelve functions and their substitutes on a scale of low to high; and
(b) said assessment means consists of evaluating any number of cognitive trait items to indicate a degree of preference of said entity for each of said trait items that are individually related to each of said twelve functions and their substitutes.

15) A system and method comprising the step of combining four individual Reasoning functions into four other new and distinct combinations of Reasoning cognition, referred to as quadrants, wherein:
(a) said four quadrants are made up of combinations of one cognitive function from a first Reasoning pair consisting of a Reality function plus an Imagination function, and one function from a second Reasoning pair consisting of an Analysis function plus an Intuition function;
(b) said resulting quadrants are individually referred to as a Creative Quadrant, a Strategic Quadrant, an Organizational Quadrant, and an Achievement Quadrant; and
(c) each of said cognitive functions and said quadrant combinations may be referred to in the form of a noun, verb, adjective, and other equivalent descriptive word.

16) The system and method as claimed in claim 15 further comprising the step of matching said four cognitive functions of Reasoning in pairs of complementary left-brain style and right-brain style functions wherein:
(a) said Reality function is paired with said Imagination function and said Analysis function is paired with said Intuition function;
(b) said functions of Reality and Analysis are associated with a slower, objective, conscious, and divergent left-brain style of serial cognitive processing; and
(c) said functions of Imagination and Intuition are associated with a faster, subjective, subconscious, and convergent right-brain style of parallel cognitive processing.

17) The system and method claimed in claim 15 further comprising the step of further identifying the characteristics and attributes of said four quadrants as:
(a) said Creative Quadrant combining all the characteristics and attributes of said functions of Imagination plus Intuition;
(b) said Strategic Quadrant combining all the characteristics and attributes of said functions of Imagination plus Analysis;
(c) said Organizational Quadrant combining all the characteristics and attributes of said functions of Reality plus Analysis; and
(d) said Achievement Quadrant combining all the characteristics and attributes of said functions of Reality plus Intuition.

18) The system and method as claimed in claim 15 further comprising the step of assessing the extent of preference of an entity for each of said four quadrants using a preference survey instrument wherein:
(a) said preference survey instrument uses an assessment means to establish a degree of preference of said entity for each of said four functions on a scale of low to high;
(b) said assessment means consists of evaluating any number of cognitive trait items to indicate a degree of preference of said entity for each of said trait items that are individually related to each of said four functions;
(c) an extent of preference for each of said four quadrants is determined by the cumulative extent of preference for said two functions of each quadrant.
(d) a means of reporting this information to said entity is used to convey the nature and extent of the cognitive function preferences of the individual and to use ths information for cognitive development purposes.
